(19) United States
(12) Patent Application Publication
(10) Pub. No.: US 2024/0106384 A1
(43) Pub. Date: Mar. 28, 2024

(54) MODULAR CANOPY SYSTEM

(71) Applicant: Nick Hammer, Bountiful, UT (US)

(72) Inventor: Nick Hammer, Bountiful, UT (US)

(21) Appl. No.: 18/472,434

(22) Filed: Sep. 22, 2023

Related U.S. Application Data
(60) Provisional application No. 63/376,795, filed on Sep. 23, 2022.

(51) Int. Cl. H02S 20/21; B32B 1/00; B32B 3/18; B32B 27/06; B32B 27/32; E01C 11/24; E04B 1/32; H02S 30/20; H02S 40/36

(52) U.S. Cl. CPC H02S 20/21; B32B 1/00; B32B 3/18; B32B 27/06; B32B 27/322; E01C 11/24; E04B 1/3205; H02S 30/20; H02S 40/36; E04B 2001/3252; F24F 2007/004

(57) ABSTRACT

A modular canopy system rests upon a solid surface of the earth. The modular canopy system includes a supporting structure including a plurality of pillars disposed on edges of the solid surface of the earth. The modular canopy system further includes a plurality of modules resting upon the supporting structure. Each of the plurality of modules includes: (i) a hollow frame; (ii) a first translucent plastic layer for shielding the solid surface of the earth from heat and allowing sunlight to enter through; (iii) a second translucent plastic layer for shielding the solid surface of the earth from heat and allowing sunlight to enter through; and (iv) a photovoltaic layer including a plurality of photovoltaic panels for receiving solar radiation and converting the solar radiation to electricity. The modular canopy system further includes a rainwater collection and harvesting module for receiving and collecting rainwater.

### CROSS-REFERENCE TO RELATED APPLICATION

The present application claims priority under 35 U.S.C. § 119 to U.S. Provisional Application No. 63/376,795, entitled “MODULAR CANOPY SYSTEM”, filed on Sep. 23, 2022, the entirety of which is incorporated by reference herein.

### FIELD OF INVENTION

The described examples relate to systems and techniques for solar energy conversion, rainwater collection, noise reduction, mechanical ventilation, and direct air capture technologies.

### BACKGROUND

Globally, CO₂ levels are elevated and continue to rise. Pre-industrialization levels of CO₂ were around 290 ppm (parts per million), whereas as such levels are now up above 420 ppm, and climbing. Cities consistently see 10-20% higher concentrations of CO₂ across metropolitans and even higher concentrations along freeways, which cause enormous environmental damage. CO₂ is used as a standard unit of measure world-wide for identification of greenhouse gas (GHG) emissions that are targeted to be reduced. But GHG emissions and air pollution are composed of many other harmful elements, such as NO₂, SOx, O₃, methane, volatile organic compounds (VOCs), etc. Many of these components, while less persistent in the atmosphere, are atomically more caustic than CO₂ and need to be filtered as well.

Our highways and transportation infrastructures create waste in many forms. Vehicles that travel across our roadways release air polluting emissions that blend with the air people breathe while at the same time contributing to a surplus of atmospheric carbon. The sounds generated by combustion engines at high speeds in combination with rubber tires on pavement greatly disturbs surrounding communities with noise pollution. Rainwater falling on our roadway surfaces goes uncollected and unusable until treated while simultaneously creating hazardous travel conditions. Meanwhile, radiation from the sun on the vast surface areas of our roads creates hot microclimates while such solar energy goes unharvested.

While governments are increasingly turning to solar farms and direct air capture (DAC) farms for renewable energy solutions and negative emission technologies, many of these solutions may only be feasible in rural locations where land is a less costly resource relative to urban metropolitans. Therefore, local, state, and federal governments are looking for new approaches and systems to convert solar energy, filter and clean air polluting emission, collect rainwater, and reduce noise pollution to deliver a better transportation experience to travelers and to improve the quality of life for roadway adjacent communities.

### SUMMARY

In one example, a modular canopy system resting upon a solid surface of the earth is disclosed. The modular canopy system includes a supporting structure including a plurality of pillars disposed on edges of the solid surface of the earth. The modular canopy further includes a plurality of modules resting upon the supporting structure. Each of the plurality of modules includes a hollow frame. Each of the plurality of modules further includes a first translucent plastic layer for shielding the solid surface of the earth from heat and allowing sunlight to enter through. Each of the plurality of modules further includes a second translucent plastic layer for shielding the solid surface of the earth from heat and allowing sunlight to enter through. Each of the plurality of modules further includes a photovoltaic layer including a plurality of photovoltaic panels for receiving solar radiation and converting the solar radiation to electricity. The modular canopy system further includes a rainwater collection and harvesting module for receiving and collecting rainwater.

In another example, the plurality of modules may be rhombus shaped.

In another example, the plurality of modules may further form a gridshell structure by assembling the plurality of modules into a larger unit.

In another example, the hollow frame may be rhombus-shaped formed by a first hollow conduit, a second hollow conduit, a third hollow conduit, and a fourth hollow conduit.

In another example, the first hollow conduit may be in parallel to the third hollow conduit and the second hollow conduit is in parallel to the fourth hollow conduit.

In another example, the first hollow conduit, the second hollow conduit, the third hollow conduit, and the fourth hollow conduit may further form a plurality of mechanical capture air channels for extracting carbon dioxide out of air.

In another example, the photovoltaic layer may be disposed between the first translucent plastic layer and the second translucent plastic layer.

In another example, the photovoltaic layer may be rhombus shaped by arranging the plurality of photovoltaic panels in spaced apart relation and interconnecting the adjacent photovoltaic panels with wires.

In another example, the first translucent plastic layer and the second translucent plastic layer may be rhombus shaped.

In another example, edges of the first translucent plastic layer and edges of the second translucent plastic layer connect the hollow frame.

In another example, the hollow frame may further include electrical wires connecting the plurality of photovoltaic panels for transferring the electricity converted by the photovoltaic panels.

In another example, the first translucent plastic layer and the second translucent plastic layer may include a Ethylene Tetrafluoroethylene (ETFE) and form an inflated pneumatic pillow.

In another example, the plurality of pillars may be arranged in spaced apart relation above the solid surface of the earth to form passive ventilation near the solid surface of the earth where colder air passively circulates pollution into the plurality of rhombus-shaped modules.

In another example, the solid earth surface may include a roadway.

In another example, the hollow frame may include a hollow conduit defining an interior electric wiring channel, an interior rainwater diversion channel, and an interior ventilation channel.

In another example, the hollow frame may define a series of ventilation openings extending through the frame and defining a ventilation passage between the interior ventilation channel and an environment under the canopy system.

In another example, the hollow frame may define a series of longitudinal attachment features configured to secure one or both of the first translucent plastic layer or the second translucent plastic layer.

In another example, a system is disclosed. The system includes a modular canopy system, such as any of the modular canopy system described herein. The system further includes a portion of a vehicular highway arranged fully under the plurality of modules of the modular canopy system.

In another example, a method is disclosed. The method includes providing a modular canopy system, such as any of the modular canopy systems described herein. The method further includes receiving, by the photovoltaic layer, solar radiation. The method further includes converting the solar radiation to electricity. The method further includes receiving, at the rainwater collection and harvesting module, rainwater.

In another example, the method may further include mechanically capturing air from below the modular canopy system into one or more hollow conduits of the hollow frame.

In addition to the example aspects described above, further aspects and examples will become apparent by reference to the drawings and by study of the following description.

### BRIEF DESCRIPTION OF THE DRAWINGS

FIG. 1 depicts a perspective view of a modular canopy system near an entrance of a roadway.

FIG. 2A depicts an exemplary exploded isometric diagram of a module of the modular canopy system.

FIG. 2B depicts an isometric diagram of the module of FIG. 2A.

FIG. 3A depicts an example side schematic view of an example modular canopy system illustrating mechanical air capture along a roadway.

FIG. 3B depicts an example front schematic view of an example modular canopy system illustrating mechanical air capture along a roadway.

FIG. 4A depicts a front schematic view of an example traditional road barrier.

FIG. 4B depicts a front schematic view of a noise reduction barrier provided by an example modular canopy system.

FIG. 5 depicts an example cross-section of a rainwater collection and harvesting module in the modular canopy system.

FIG. 6 depicts an example structural support module of the modular solar canopy.

FIG. 7 depicts a flow diagram of an example method of operating a modular canopy system.

### DETAILED DESCRIPTION

The present application discloses a modular canopy system resting on a roadway to deliver safe, sustainable, intelligent, and environment-friendly transportation solutions. The illustrated embodiment is not intended to be limiting, and the modular canopy system may have other configurations, constructions, and materials other than those listed below.

The following disclosure relates to a modular canopy system that integrates solar energy conversion, rainwater collection, noise reduction, and mechanical ventilation techniques into a single, modularly constructed structure. In one example, the modular canopy system includes of a plurality of rhombus-shaped modules formed in a gridshell superstructure. Each module may include one or more photovoltaic layers that are configured to harvest solar energy. The photovoltaic layers may be integrated with and arranged between protective plastic layers, such as that formed from Ethylene Tetrafluoroethylene (ETFE) and/or other appropriate material. The protective plastic layers are connected with hollow frame structures that, collectively, form a module of the modular structure. The hollow frame structure may be formed from hollow metal frames, frames formed from a synthetic material, and/or certain carbon fiber materials, among other options, as may be selected based on the structural considerations of the system.

A plurality of such modular structures may be arranged with one another to from the gridshell superstructure. In addition to each module collecting solar energy, the modules may cooperate to collectively capture rainwater, and to facilitate noise reduction, and direct air capture. For example, the modular canopy system may operate by passively and mechanically pulling polluted air through the superstructure itself and filter the pollutants, which may allow the canopy system to function as a Direct Air Capture (DAC) system. The modular structures help concentrate and encapsulate mobile source pollutants, and protect the transportation corridor below from weather. The ETFE layers may be or otherwise define inflated pneumatic pillows that infill the superstructure except near the ground where cooler air will help passively circulate pollution into the DAC system. Additionally, each module may include a water channel formed by a series of ridges in the tube. The water channel may facilitate the collection of water at each module. The channels may, in turn, be associated with channels of adjacent modules in order to route the collected rainwater to a base portion of the canopy system for collection and processing, such as to recycle the water for consumption, among other uses.

The embedded layer of photovoltaics within the ETFE will have a variable density based on location and visibility needs. In some cases, a single mile of canopy will produce ˜5 MW of power per mile based on the width and length of the road in relation to the solar insolation per location. This is also at a coverage ratio of around 25%. The modular solar canopy system may also utilize airspace over roadways to facilitate large urban grid scale solar farms that may be substantially larger than any existing system. Urban solar reduces transmission loss, prevents greenfield sites in rural locations, and provides clean energy jobs directly into the heart of the city. In sum, the modular canopy system is configured to reduce air and noise pollution, protect transportation and travelers, recycle and sequester carbon and captured pollutants, act as an urban solar farm, thereby improving the lives of those that live adjacent to it.

It should be understood, of course, that the foregoing relates only to preferred embodiments of the present invention and that numerous modifications or alterations may be made therein without departing from the spirit and the scope of the invention as set forth in the appended claims. Such alternate embodiments are considered to be encompassed within the spirit and scope of the present invention. The present invention discloses a number of modifications or alterations of the canopy system. For example, the canopy system may also be used to build an agriculture greenhouse and a manufacturing warehouse.

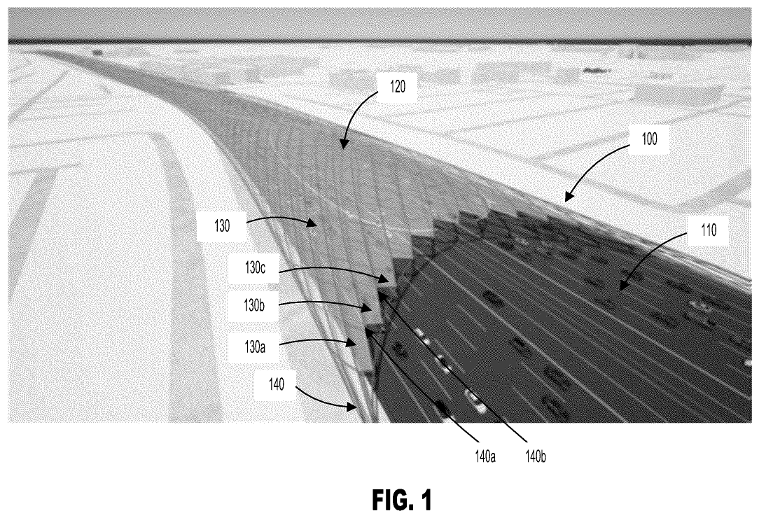

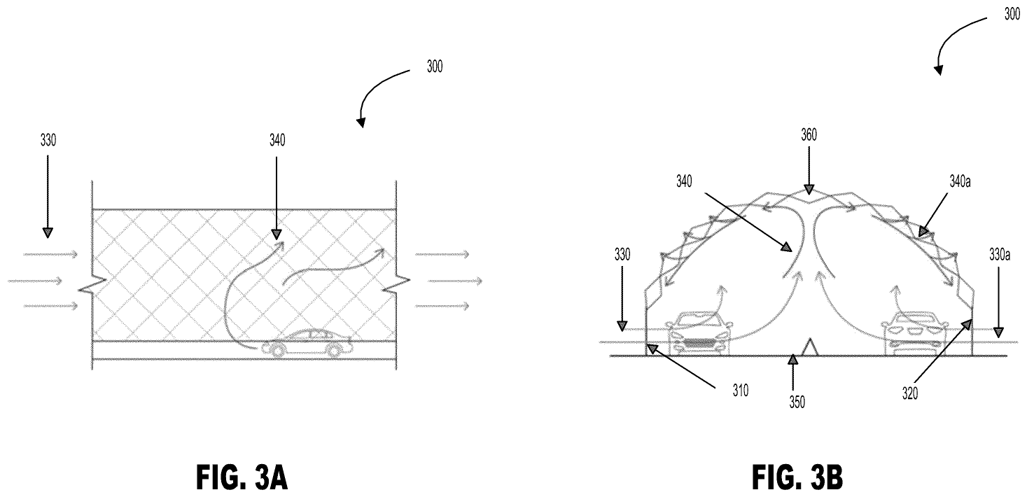

FIG. 1 illustrates an embodiment of the disclosed modular canopy system 100 associated with a roadway 110. The modular canopy system 100 may be formed from a large-spanning gridshell superstructure 120 that is arranged over and resting or support along the roadway 110. The gridshell superstructure 120 itself consists of a plurality of self-similar structural modules 130 to form a robust structure through redundant structural connections and nodes. For example, and as shown in FIG. 1, a given module 130a may be connected to an adjacent module 130b at a first node 140a. The adjacent module 130b may, in turn, be connected to another module 130c at second node 140b, and so in order to define, collectively, the large-spanning gridshell superstructure 120. Each of the module 130 may rhombus shaped. The plurality of rhombus-shaped modules 130 are assembled into a larger unit 120. The larger unit 120 is further supported by a plurality of pillars that are arranged in spaced apart relation above a ground surface of the roadway, for example, such as via pillars 310, 320, as shown in FIG. 3B herein.

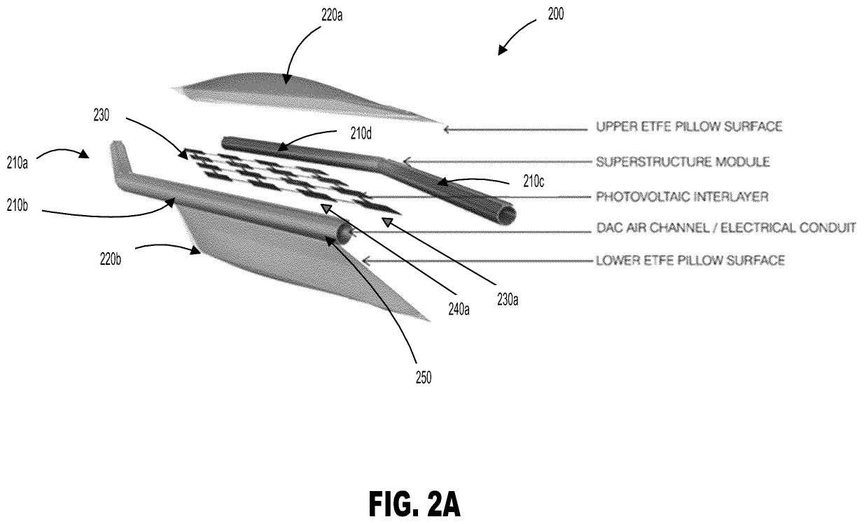

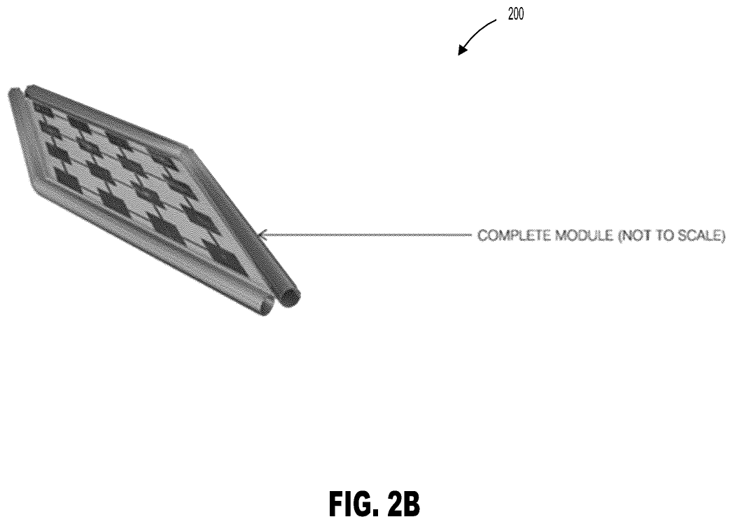

FIGS. 2A and 2B illustrate an example rhombus-shaped module 200 of the canopy system 100 of FIG. 1. The rhombus-shaped module 200 is formed by four hollow conduits 210a, 210b, 210c, 210d, two ETFE (Ethylene Tetrafluoroethylene) films 220a, 220b, and a plurality of photovoltaic panels 230a that cooperate to define a photovoltaic interlayer 230. The hollow conduits 210a-d include air channels 250 to pass through air flows of carbon dioxide and/or other pollutions that are generally collected from the modular canopy system. In another example, the hollow conduits 210a-d also include electrical circuits to transfer electricity converted from solar energy by the photovoltaic interlayer 230. The ETFE films 220a, 220b may have a 95% translucence, be 1/100th the weight of glass, and may provide superior thermal and sound performance. It has been proven to be an easily repairable, and recyclable material with no UV degradation over 50+ years equivalent of testing. The two ETFE films 220a, 220b, are attached on the hollow conduits to create an inflated pneumatic pillow by filling with low-pressure air, such that it can provide thermal insulation and structural stability against wind and snow loads. Specifically, the ETFE inflated pneumatic pillow acts as a thermal barrier that helps shield the corridor from excessive heat, which is critical for hot climates where traffic can be idle for long periods. The reverse is true for helping mitigate heat island effect, helping abate large swaths of low albedo and dark urban land and reduce impermeable surfaces.

Further, the plurality of photovoltaic panels 230a may be arranged in spaced apart relation to form a rhombus-shaped photovoltaic layer 230, wherein each photovoltaic panel interconnects its adjacent photovoltaic panels with wires 240a. The rhombus-shaped photovoltaic layer 230 is sandwiched by the two ETFE films 220a, 220b. The rhombus-shaped photovoltaic layer 230 captures solar power and converts it into electrical energy. For example, the photovoltaic layer 230 within the ETFE inflated pneumatic pillow will have a variable density based on location and visibility needs. Initial calculations suggest that a single mile of the modular canopy system 100 can produce ˜5 MW of power per mile based on the width and length of the road in relation to the solar insolation per location. This is also at a coverage ratio of 25%. The modular canopy system 100 of FIG. 1 will utilize airspace over roadways to become an urban grid scale solar farm. Urban solar reduces transmission loss, prevents greenfield sites in rural locations, and provides clean energy jobs directly into the heart of the city.

FIGS. 3A and 3B are example schematic views of the modular canopy system 300 illustrating mechanical ventilation for emission pollution using passive ventilation. For example, and as shown in FIGS. 3A and 3B, the plurality of pillars 310, 320, are arranged in spaced apart relation to form a passive ventilation system so that external air can be pulled into the modular canopy system 300 with natural forces, such as wind and thermal buoyancy. For example, wind-driven ventilation arises from the different pressures created by wind around the modular canopy system and openings being formed by the plurality of pillars 310, 320. The wind-driven ventilation permits colder air flow 330 through the bottom of the modular canopy system 300 that near the ground of the roadway 350 to the top of the modular canopy system 300 where the plurality of rhombus-shaped modules 360 are located. The colder air 330 carries carbon dioxide and other pollutions and passes through the air channel within the hollow conduits of the plurality of rhombus-shaped modules. In some example, within the hollow conduits, there exists chemicals which react with the carbon dioxide molecules, extracting them from the air and trapping them for disposal; however, this is not required. The extracted air 340 is then escaped to the exterior of the modular canopy system 300.

In another example, thermal buoyancy-driven ventilation occurs as a result of the temperature difference between the air inside the modular canopy system 330 and air outside the modular canopy system 340. This variance causes the warm air 340 to rise above the cool air 330 and create an upward airstream. Similar to the wind-driven ventilation, the thermal buoyancy-driven ventilation permits colder air 330 enter the modular canopy system 300 through the openings formed by the plurality of pillars 310, 320. As the temperature of colder air 330 increases in the modular canopy system 300, the warmer air 340 then carries carbon dioxide and other pollutions to pass through the DAC air channel within the hollow conduits of the plurality of rhombus-shaped modules 360. The chemicals within the hollow conduits react with the carbon dioxide molecules, extracting them from the air and trapping them for disposal. The extracted air is then escaped to the exterior of the modular canopy system 300.

As illustrated in FIG. 3B, outside colder air 330, 330a enters the modular canopy system 300 through the openings formed by the plurality of pillars 310, 320. Because of the higher temperature within the modular canopy system 300 and greenhouse gas emissions from vehicles, the colder air 330, 330, which is lighter, become warmer air 340, 340a, which is heavier. The temperature difference between the colder air 330, 330a and warmer air 340, 340a, drive the air flow. The warmer air 340, 340a escapes the modular canopy system 300 through its hollow conduits.

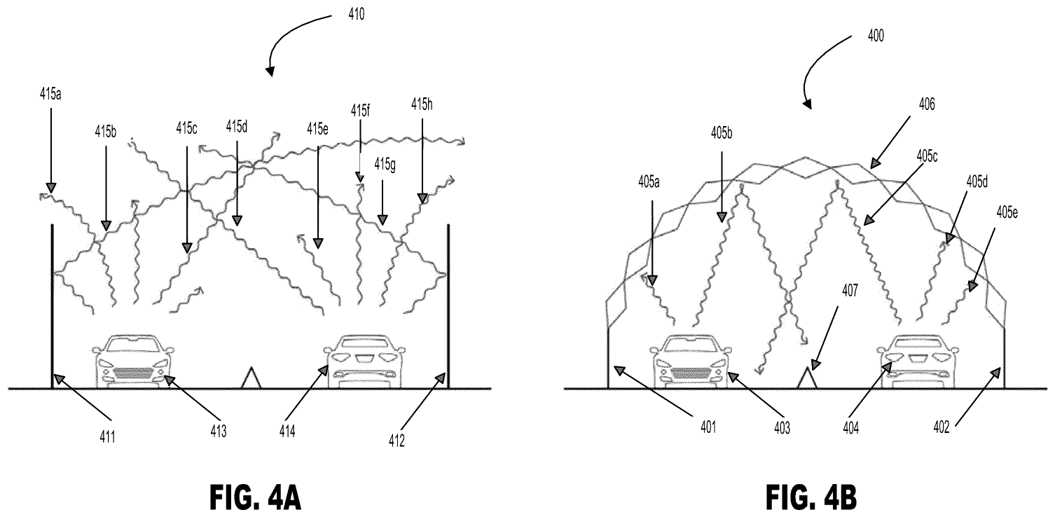

FIGS. 4A and 4B illustrate noise reduction performance between a conventional noise barrier 410 (FIG. 4A) and the modular canopy system 400 (FIG. 4B). The ETFE inflated pneumatic pillow of the modular canopy system 400 provides an 8-10 dB reduction that matches the effectiveness of traditional concrete road barriers 411, 412, but with the magnitude greater benefit of not allowing sound to bounce over or escape the modular canopy system 400. This will greatly reduce noise pollution to nearby communities. Additionally, the bumped interior surface avoids noise concentration.

The conventional noise barrier 410 is usually built as two walls 411, 412 alongside the roadway. The conventional noise barrier mitigates the noise level by reducing the noise propagation and absorbing noises with some sound-absorbing materials. For example, vehicles 413, 414 generate noises 415a-h in different directions. The noise emissions 415b, 415g, propagate and are blocked by the walls 411, 412. They are reflected and escape the conventional noise barrier 410 in another directions, respectively. Part of the noises 415b, 415g are absorbed and the attenuations of the noises are reduced. Due to the height limit of the wall 411, 412, noise emissions 415a, 415c-f, 415h escape the conventional noise barrier 410 directly without absorbing or reflecting. In this situation, the noises are not effectively reduced and will cause annoying noise pollutions in nearby communities.

The modular canopy system 400 includes a plurality of pillars 401, 402 acting similar function as the conventional noise barrier 410. In addition, the plurality of rhombus-shaped modules 406 form a gridshell superstructure that bounces the noise back and disallows noises them from escaping the modular canopy system 400. For example, vehicles 403, 404 generate noise emissions 405a-405e. The noises 405b, 405c hit the surface of the modular canopy system 400 and thereafter are bounced back. But they cannot escape from the modular canopy system 400. This will greatly reduce noise pollution to nearby communities, while the bumped interior surface 407 will also avoid noise concentration and focusing common in typical concrete tunnels.

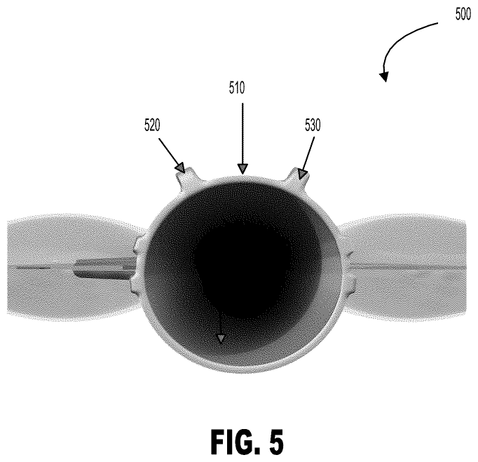

FIG. 5 is an exemplary view of rainwater collection and harvesting module 500 in the modular canopy system 100 of FIG. 1. On top end of each hollow conduit of the rhombus-shaped module, a water channel 510 is formed by ridges 520, 530 of metal conduits (such as any or all of the conduits 210a-d of FIG. 2) to carry rainwater to the bottom region 140 of the modular canopy system 100 which is connected to the curbs of the roadway. The rainwater is further directed to a specified area, such as a detention basin or a cistern, for water collection and treatment.

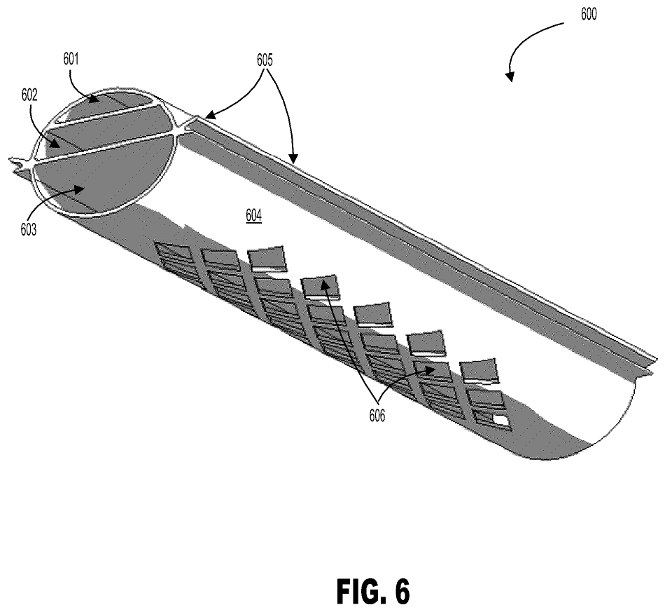

FIG. 6 illustrates an example structural support module 600 assembling the hollow conduits 210a-d of the rhombus-shaped module 200 of FIG. 2. The structural support module 600 may be formed from any of a variety of materials that may be configured to withstand different environment conditions, such as exposure to sun, corrosivity of rainwater, sun, wind, snow, air pollutants, animal manure, and temperature changes. For example, in some cases, the structural support module 600 may be formed by two pieces of curved stainless-steel plates 604 capable of withstanding temperatures in excess of 200° C. or greater. The two pieces of curved stainless-steel plates 604 may be coupled to one another via a connecting piece 605 on the edges. In an alternative example, the structural support module 600 may generally be defined as a unitary or one-piece structure.

The cross-section of the structural support module 600 may be any of a variety of shapes, such as circle, ellipse, hexagon, heptagon, octagon, and nonagon. As illustrated in FIG. 6, the structural support module 600 has an elliptical cross section and is a multi-channel structure that include an electrical wiring channel 601, a rainwater diversion channel 602, and a ventilation channel 603. The cross-section of the ventilation channel 603 may be larger than the cross-sections of the electrical wiring channel 601 and the rainwater diversion channel 602, respectively. The curved stainless-steel plate 604 that forms the ventilation channel 603 includes a plurality of openings 606 into the ventilation channel. The openings 606 can be any of a variety of shapes, such as diamond, square, rectangle, triangle, rhombus, etc.

In operation, the electrical wiring channel 601 is used for storing electricity wires to transfer the electricity converted by the photovoltaic panels of the rhombus-shaped module 200 in the canopy system. The rainwater diversion channel 602 is used to collect and direct rainwater to a specified area, such as a detention basin or a cistern, for water collection and treatment. The ventilation channel 603 is used for mechanical ventilation. The connecting piece 605 may be used as an attachment point to mount the ETFE films 220a, 220b, and the photovoltaic layer 230 of the rhombus-shaped module 200 in FIG. 2.

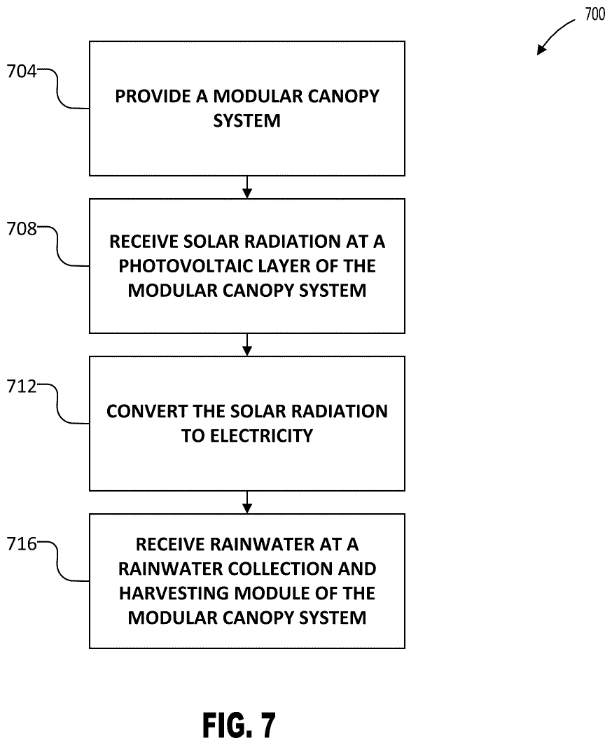

FIG. 7 depicts a flow diagram of an example method 700 of operating a modular canopy system, such as operating any of the modular canopy systems disclosed herein. At operation 704, a modular solar canopy is provided. For example, and with reference to FIG. 1, the modular canopy system 100 may be provided. The modular canopy system 100 may be provided above a roadway and/or other solid surface of earth, including certain agriculture fields. At operation 708, solar radiation is received at a photovoltaic layer of the modular canopy system. For example, and with reference to FIGS. 1 and 2A, solar radiation may be received at a photovoltaic layer 230 of one or more modules of the solar canopy system 100. In turn, at operation 712, solar radiation is coverted to electricity, for example, using said photovoltaic layer 230 and/or other system. The photovoltaic layer 230 may be used to transfer said electricity and/or other signals to a battery, power grid and/or other component via wires arranged through one or more conduits of the modular canopy system. At operation 716, rainwater is received at a rainwater collection and harvesting module of the modular canopy system. For example, and with reference to FIGS. 2A, 5, and 6 rainwater may be received at a water channel 510 of one or more of the conduits of the canopy system. Said rainwater may be received by the conduit and routed through the conduits (e.g., via the rainwater diversion channel 602) to a central storage facility.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A modular canopy system resting upon a solid surface of the earth, the modular canopy system comprising:
a supporting structure including a plurality of pillars disposed on edges of the solid surface of the earth;
a plurality of modules resting upon the supporting structure, each of the plurality of modules comprising:
a hollow frame;
a first translucent plastic layer for shielding the solid surface of the earth from heat and allowing sunlight to enter through;
a second translucent plastic layer for shielding the solid surface of the earth from heat and allowing sunlight to enter through;
a photovoltaic layer including a plurality of photovoltaic panels for receiving solar radiation and converting the solar radiation to electricity; and
a rainwater collection and harvesting module for receiving and collecting rainwater.

2. The modular canopy system of claim 1, wherein the plurality of modules are rhombus shaped.

3. The modular canopy system of claim 1, wherein the plurality of modules further form a gridshell structure by assembling the plurality of modules into a larger unit.

4. The modular canopy system of claim 1, wherein the hollow frame is rhombus-shaped formed by a first hollow conduit, a second hollow conduit, a third hollow conduit, and a fourth hollow conduit.

5. The modular canopy system of claim 4, wherein the first hollow conduit is in parallel to the third hollow conduit and the second hollow conduit is in parallel to the fourth hollow conduit.

6. The modular canopy system of claim 4, wherein the first hollow conduit, the second hollow conduit, the third hollow conduit, and the fourth hollow conduit further form a plurality of mechanical capture air channels for extracting carbon dioxide out of air.

7. The modular canopy system of claim 1, wherein the photovoltaic layer is disposed between the first translucent plastic layer and the second translucent plastic layer.

8. The modular canopy system of claim 1, wherein the photovoltaic layer is rhombus shaped by arranging the plurality of photovoltaic panels in spaced apart relation and interconnecting the adjacent photovoltaic panels with wires.

9. The modular canopy system of claim 1, wherein the first translucent plastic layer and the second translucent plastic layer are rhombus shaped.

10. The modular canopy system of claim 1, wherein edges of the first translucent plastic layer and edges of the second translucent plastic layer connect the hollow frame.

11. The modular canopy system of claim 1, wherein the hollow frame further includes electrical wires connecting the plurality of photovoltaic panels for transferring the electricity converted by the photovoltaic panels.

12. The modular canopy system of claim 1, wherein the first translucent plastic layer and the second translucent plastic layer are Ethylene Tetrafluoroethylene (ETFE) and form an inflated pneumatic pillow.

13. The modular canopy system of claim 1, wherein the plurality of pillars are arranged in spaced apart relation above the solid surface of the earth to form passive ventilation near the solid surface of the earth where colder air passively circulates pollution into the plurality of rhombus-shaped modules.

14. The modular canopy system of claim 1, wherein the solid earth surface comprises a roadway.

15. The modular canopy system of claim 1, wherein the hollow frame comprises a hollow conduit defining an interior electric wiring channel, an interior rainwater diversion channel, and an interior ventilation channel.

16. The modular canopy system of claim 15, wherein the hollow frame defines a series of ventilation openings extending through the frame and defining a ventilation passage between the interior ventilation channel and an environment under the canopy system.

17. The modular canopy system of claim 16, wherein the hollow frame defines a series of longitudinal attachment features configured to secure one or both of the first translucent plastic layer or the second translucent plastic layer.

18. A system comprising
the modular canopy system of claim 1, and
a portion of a vehicular highway arranged fully under the plurality of modules of the modular canopy system.

19. A method comprising
providing the modular canopy system of claim 1;
receiving, by the photovoltaic layer, solar radiation;
converting the solar radiation to electricity; and
receiving, at the rainwater collection and harvesting module, rainwater.

20. The method of claim 19, further comprising mechanically capturing air from below the modular canopy system into one or more hollow conduits of the hollow frame.
